(19) United States
(12) Patent Application Publication
(10) Pub. No.: US 2004/0017634 A1
(43) Pub. Date: Jan. 29, 2004

(54) Portable storage device

(76) Inventors: Chang Chin-Lung, Taiwan (CN); Hui-Ming Chu, Taiwan (CN)

Correspondence Address: SHAW PITTMAN, IP GROUP, 1650 TYSONS BOULEVARD, SUITE 1300, MCLEAN, VA, 22102, US

(21) Appl. No.: 10/266,575

(22) Filed: Oct. 9, 2002

(30) Foreign Application Priority Data
Jul. 26, 2002 (CN) 091211541

(51) Int. Cl. G11B 5/012

(52) U.S. Cl. 360/97.01

(57) ABSTRACT

A portable storage device capable of being abreast used with another device comprises a main body having a lamp portion and a connecting portion connected to the main body via a connecting line. When the connecting portion is situated at a first position, the connecting portion and a part of the connecting line are exposed outside the main body, and the portable storage device is at a status of being abreast used. When the connecting portion is situated at a second position, the connecting portion is exposed outside the main body, and the portable storage device is at a status of being singly used. When the connecting portion is situated at a third position, the connecting portion is hidden in the main body, and the portable storage device is at a status of being housed.

### BACKGROUND OF THE INVENTION

1. Field of the Invention

The present invention relates to a portable storage device, and particularly to a USB portable disk drive (Handy Drive) having no separated covering and being able to be abreast used together with another device.

2. Description of the Prior Art

As computer technology advances, there is a trend to develop smaller and portable storage devices. Now, various portable storage devices, such as a portable disk drive, are common in the market, and most of them are connected to computers via universal serial bus (USB) interfaces.

FIG. 1a is a perspective diagram of a conventional USB portable disk drive 500. The drive 500 comprises a main body 510 having a storage portion, such as a flash memory, and a covering 520 separated form the main body for covering a USB terminal 515. In addition, the main body 510 further comprises an indicator light 530, such as a light-emitting diode (LED), for showing the operating status of the portable disk drive 500. Before using the USB portable disk drive 500, the user has to remove the covering 520 and plug the USB terminal 515 into a USB socket of the computer. When data is accessed and transmitted between the drive 500 and computer, the indicator light 530 will be turned on so as to emit light and show the USB portable disk drive 500 is at a status of being used. When finishing the use of the drive 500, the user can cover the USB terminal 515 with the covering 520 so as to protect the USB terminal 515 and keep it from dust. In addition, a hanging portion (not shown), such as a hooking ring or a hanging hole, can be installed on the main body 510 or the covering 520 so that the user can hang the drive 500 on the neck and carry it with him or her.

However, the conventional USB portable disk drive 500 has the following drawbacks when it is being used and carried.

First, the conventional USB portable disk drive 500 has a separated covering 520 for covering the USB terminal 515. When the user removes the covering 520 and uses the USB portable disk drive 500, he or she usually lays the covering 520 aside. Therefore, the user tends to lose the covering 520 for the carelessness especially when the USB portable disk drive 500 is repeatedly plugged into the computer for data accessing and taken out from the computer. Losing the covering 520 not only makes it impossible to keep the USB terminal 515 from the dust, but also damages the integrity of the external shape of the USB portable disk drive 500.

Furthermore, the indicator light 530 of the conventional USB portable disk drive 500 is a small LED, and therefore, no matter which position the LED is situated at, the light of the indicator light 530 cannot be easily identified from various angles. Particularly, when the computer system has various peripheral devices, the light emitted by the indicator light 530 will be affected by the surroundings or the other peripheral devices and cannot be easily identified. Consequently, the user tends to misjudge that the data accessing of the USB portable disk drive 500 is finished and then takes out the drive 500 when the drive 500 is still performing the data accessing so that the data accessing will be abnormally interrupted and the data may be damaged.

Please refer to FIGS. 1b and 1c. They show the situation when the conventional USB portable disk drive 500 is attached to a device having several USB sockets 62. The device 60 is a device having several USB sockets, such as a computer, and the devices 62 are USB sockets of the computer 60. The USB sockets 62 shown in FIG. 1b are arranged in a line, and the USB sockets 62 shown in FIG. 1c are arranged in parallel.

The main body 510 of the conventional USB portable disk drive 500 has several components, such as a storage portion, arranged on a motherboard so that the space occupied by the main body 510 is generally considerable. As the capacity of the storage portion is increased the main body tends to occupy more space. Therefore, when the USB portable disk drive 500 is attached to the computer with several USB sockets 62, no matter how the USB sockets 62 are arranged, the main body 510 will exceed the middle line between the two adjacent USB sockets 62. The reference symbols d1 and d2 in FIGS. 1b and 1c illustrate the situation. Thus, if the user wants to use two USB portable disk drives 500 at the same time in order to transmit or exchange data between the two USB portable disk drives 500, the main bodies 510 of the two USB portable disk drives 500 will collide with each other and cannot be directly and abreast inserted into the USB sockets 62. Therefore, the user has to slantingly insert the two USB portable disk drives 500 into the USB sockets 62, and harmful impacts are caused on the USB terminals 515 of the portable disk drives 500 and the USB sockets 62.

In addition, in the situation of only one USB portable disk drive 500 being used, it is still possible for the main body 510 of the USB portable disk drive 500 to collide with another peripheral device using USB interface and to be pushed and pressed when the space it can occupy is strictly limited. In order to resolve this problem, the manufacture can reduce the volume of the main body 510. However, for the purpose of reducing the volume of the main body, the manufacture has to alter the structural design of the main body and to change the arrangement of the motherboard of the USB portable disk drive. This will greatly increase the costs of designing and producing the USB portable disk drive.

### SUMMARY OF THE INVENTION

Therefore, the objective of the present invention is to provide a portable storage device capable of being abreast used together with another device so as to resolve the problems caused by the conventional USB portable disk drive. The connecting portion of the portable storage device is designed to be capable of being situated at different positions. When the portable storage device has to be abreast used with another device, in order to avoid collision of the devices, the connecting portion has to be situated at a position for being abreast used so as to avoid the collision. Therefore, the volume of the main body may remain the same and the cost of the portable storage device will not be greatly increased.

In the portable storage device of the invention, the connecting portion is capable of being situated at a position for being housed, and a separated covering is avoided. Furthermore, by installing a light-directing portion on the main body, when the portable storage device is being used, the user can identify the light of the lamp portion from various angles, and the misjudging can be avoided so that the portable storage device will not be taken out when the data accessing is being performed.

According to a first aspect of the invention, a portable storage device capable of being abreast used with another device is provided. The portable storage device comprises a main body and a connecting portion. The main body has a lamp portion, and the connecting portion is connected to the main body via a connecting line. The connecting portion can be moved to and situated at a first position, a second position and a third position. When the connecting portion is situated at the first position, the connecting portion and a part of the connecting line are exposed outside the main body, and the portable storage device is at a status of being abreast used with another device. When the connecting portion is situated at the second position, the connecting portion is exposed outside the main body, and the portable storage device is at a status of being used singly. When the connecting portion is situated at the third position, the connecting portion is hidden in the main body, and the portable storage device is at a status of being housed.

According to a second aspect of the invention, a portable storage device capable of being abreast used with another device is provided. The portable storage device comprises a main body and a connecting portion. The main body has a lamp portion, and the connecting portion is connected to the main body via a connecting line. The connecting portion can be moved to and situated at a first position and a second position. When the connecting portion is situated at the first position, the connecting portion and a part of the connecting line are exposed outside the main body. When the connecting portion is situated at the second position, the connecting portion can be exposed outside the main body or hidden in the main body.

In the portable storage device capable of being abreast used with another device according to the invention, the connecting portion can be a universal serial bus (USB) terminal, and the lamp portion can be a light emitting diode (LED). In addition, the connecting line has a spring portion so that when the connecting portion is situated at different positions, the connecting line will be pulled back to a reserved space in the main body by the tension of the spring portion and will not exposed.

In the portable storage device capable of being abreast used with another device according to the invention, the main body can have a light-directing portion corresponding to the lamp portion for directing the light of the lamp portion to various angles so as to make it easy for the users to identify. In addition, the main body can have a hanging portion so that the user can hang the portable storage device on the neck and carry it with him or her.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

FIG. 1a is a perspective diagram of a conventional USB portable disk drive;

FIG. 1b is a perspective diagram of an example of the conventional USB portable disk drive being installed in a device having several USB sockets;

FIG. 1c is a perspective diagram of another example of the conventional USB portable disk drive being installed in a device having several USB sockets;

FIG. 2 is a perspective diagram of an embodiment of a portable storage device capable of being abreast used with another device according to the invention;

FIG. 3a is a perspective diagram of the portable storage device in FIG. 2 at a status of being singly used;

FIG. 3b is a perspective diagram of the portable storage device in FIG. 2 at a status of being housed;

FIG. 3c is a perspective diagram of the portable storage device in FIG. 2 at a status of being abreast used;

FIG. 4 is a perspective diagram of the portable storage device in FIG. 2 being abreast used with another device;

FIG. 5a is a perspective diagram of another embodiment of a portable storage device according to the invention at a status of being singly used; and

FIG. 5b is a perspective diagram of the portable storage device in FIG. 5a at a status of being housed.

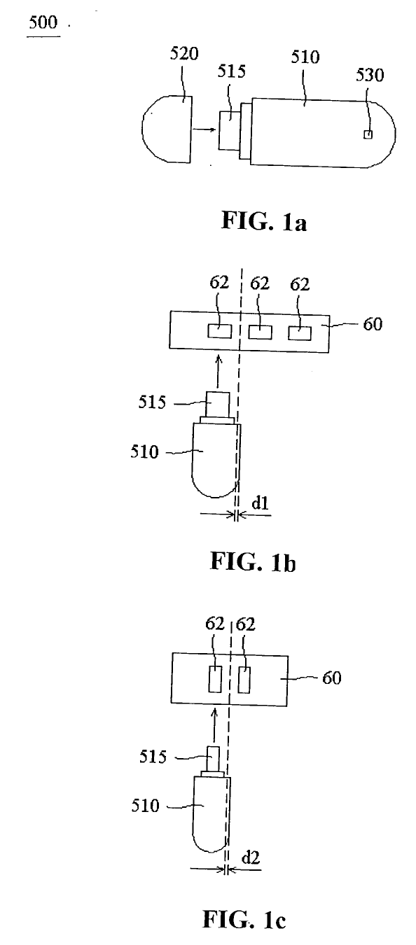

### DETAILED DESCRIPTION OF THE PREFERRED EMBODIMENT

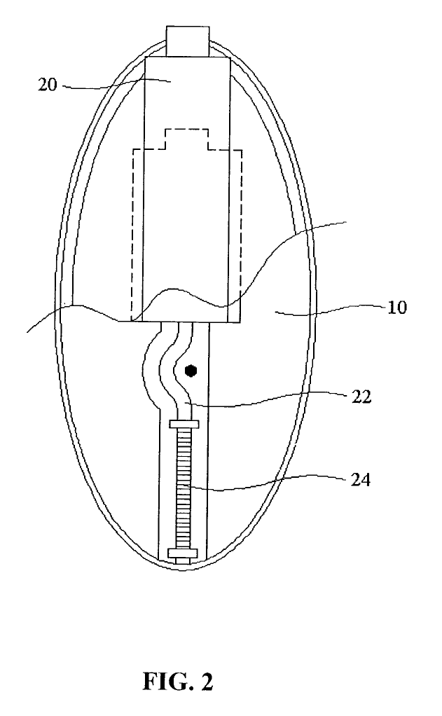

Please refer to FIG. 2. FIG. 2 is a perspective diagram of a portable storage device capable of being abreast used with another device according to the invention.

The portable storage device 1 comprises a main body 10 and a connecting portion 20. The main body 10 has a lamp portion (not shown), such as a light emitting diode (LED), for showing the operating status of the portable storage device 1. The main body 10 can have a light-directing portion corresponding to the lamp portion, such as a translucent light-directing slice, for directing the light of the lamp portion to various angles so as to make it easy for the users to identify. In addition, the main body 10 can have a hanging portion, such as a hanging hole or a hanging hook, so that the user can hang the portable storage device 1 on the neck and carry it with him or her.

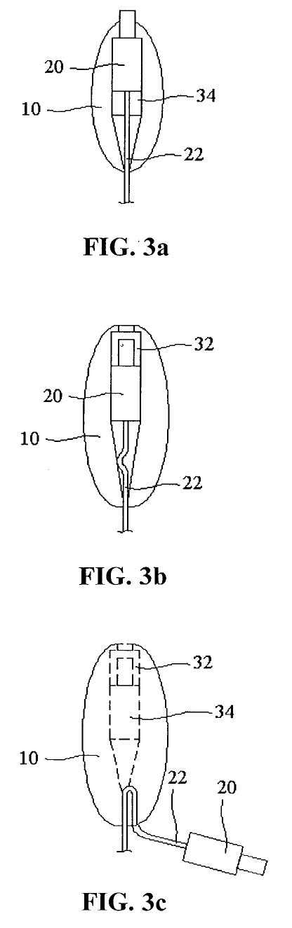

The connecting portion 20 can be a USB terminal and is connected to the main body 10 via a connecting line 22 and can be situated at different positions. Furthermore, in this embodiment, the connecting line 22 further has a spring portion 24 so that the connecting line 22 is pulled back to a reserved space in the main body 10 by means of the tension of the spring portion 24 and is not exposed when the connecting portion 20 is situated at different positions. Please refer to FIGS. 3a to 3b. They show the different statuses of the portable storage device 1 when the connecting portion 20 is situated at different positions.

As mentioned above, the portable storage device 1 of the invention can be at different operating statuses of being abreast used with another device, being used singly, or being housed in accordance with the different positions the connecting portion 20 is situated at. As shown in FIGS. 3a to 3c, the connecting portion 20 is situated at three positions.

As shown in FIG. 3a, when the connecting portion 20 is situated at a second position 32 for being singly used, the connecting portion 20 is exposed outside the main body and the portable storage device 1 is at the status of being used singly. The connecting portion 20 can be directly inserted into the USB socket of the computer for data accessing. When the use of the portable storage device 1 is finished, as shown in FIG. 3b, the connecting portion 20 is situated at a third position 34 for being housed, and the connecting portion 20 is hidden in the main body 10. At this time, the portable storage device is at the status of being housed, and the connecting line 22 is pulled back to the reserved space in the main body 10 by means of the tension of the spring portion 24. The main body 10 functions as a covering, and a separated covering is avoided.

When the user has to abreast use the portable storage device 1 together with another device or wants to keep the portable storage device 1 from colliding with other devices, as shown in FIG. 3c, the user can pull out the connecting portion 20 from the main body 10 and make the connecting portion 20 situated at a first position for being abreast used with another device. At this time, the connecting portion 20 and a part of the connecting line 22 are exposed outside the main body 10 and the portable storage device 1 is at the status of being abreast used with another device. Therefore, by adjusting the connecting line 22, the main body 10 will not collide with other devices.

It should be noticed that when the portable storage device 1 is at the status of being abreast used with another device, it also can be used singly, and is not limited to be abreast used. In other words, the user can make the connecting portion 20 situated at the second position 32 as shown in FIG. 3a, or at the first position as shown in FIG. 3c, and the operating of data accessing is independent of the position of the connecting portion 20.

The present invention is not limited to the embodiment mentioned above. Namely, it is not necessary for the connecting portion 20 of the portable storage device 1 to be switched and situated at the three positions as mentioned above. In other words, in the portable storage device 1 of the invention, the connecting portion 20 can be switched and situated at two positions. One of the two positions is the first position as shown in FIG. 3c. That is, the connecting portion 20 is pulled out from the main body 10, and the connecting portion 20 and a part of the connecting line 22 are exposed outside the main body 10. The other position can be the second position 32 as shown in FIG. 3a or the third position 34 as shown in FIG. 3b.

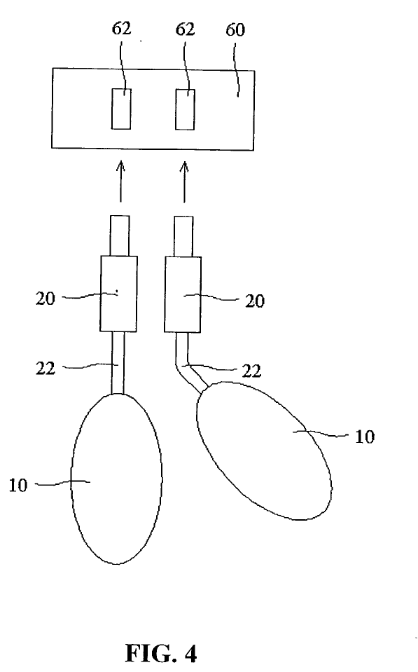

Please refer to FIG. 4. FIG. 4 shows two portable storage devices are being abreast used with each other. When the user wants to insert several portable storage devices into the USB sockets of the computer 60 (or other devices having the sockets corresponding to the connecting portion, such as a USB card-reading machine). As shown in FIG. 4, the USB sockets 62 are arranged in parallel, and the portable storage devices are at the status of being abreast used as shown in FIG. 3c. The connecting portion 20 and a part of the connecting line 22 are exposed outside the main body 10, and therefore, by bending the connecting line 22, the main bodies 10 of the two portable storage devices will not collide with each other, and the connecting portions 20 of the two portable storage devices can be directly and abreast inserted into the USB sockets 62.

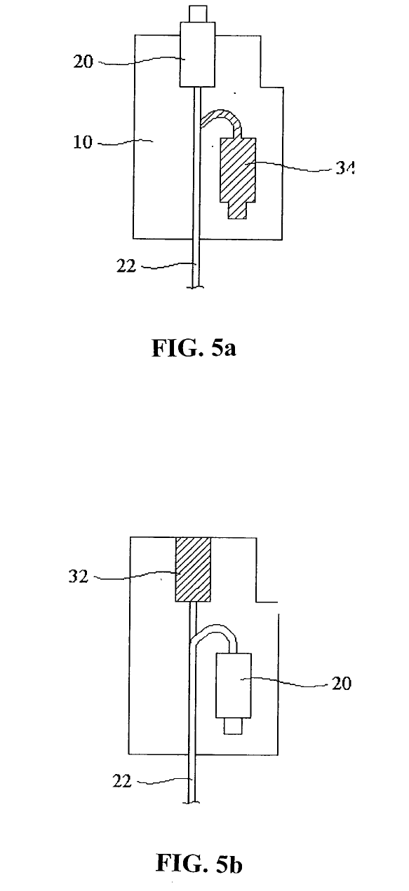

It should be noticed that the connecting line 22 has a spring portion 24 so that the connecting line 22 is pulled back to the reserved space in the main body 10 by means of the tension of the spring portion 24 and is not exposed when the connecting portion 20 is situated at different positions. However, in the portable storage device of the invention, the spring portion 24 of the connecting line 22 can be omitted. As shown in FIGS. 5a and 5b, a reserved space is reserved for the connecting line 22 when the connecting portion 20 is situated at the second position 32 and the third position 34 so that the connecting line 22 will not be exposed.

In the portable storage device of the invention, the connecting portion 20 can be switched to and situated at different positions, and therefore, the portable storage device can be singly used, abreast used or housed. Generally, the connecting portion 20 of the portable storage device is situated at the position for being singly used. When the portable storage device has to be abreast used with other devices or when the user wants to keep the portable storage device from colliding with other devices, the user can pull out the connecting portion 20 from the main body 10 and switch it to the position for being abreast used. When the use of the portable storage device is finished, the user can switch the connecting portion 20 to the position for being housed so that the connecting portion 20 is located inside the main body 10. At this time, the main body 10 functions as a covering for protecting the connecting portion 20. A separated covering is avoided and so is the problem of losing the separated covering.

In addition, in the portable storage device of the invention, the light-directing portion corresponding to the lamp portion is installed so that when the connecting portion 20 is being used, the light-directing portion will direct the light of the lamp portion to various angles. Thus, the user can easily identify the light of the lamp portion from various angles, and the misjudging can be avoided so that the portable storage device will not be taken out when the data accessing is being performed. Therefore, the present invention can resolve the problems of the conventional USB portable disk drive.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable storage device capable of being abreast used with another device comprising:
a main body having a lamp portion; and
a connecting portion connected to the main body via a connecting line, the connecting portion being moved to and situated at a first position, a second position and a third position;
wherein when the connecting portion is situated at the first position, the connecting portion and a part of the connecting line are exposed outside the main body; when the connecting portion is situated at the second position, the connecting portion is exposed outside the main body; when the connecting portion is situated at the third position, the connecting portion is hidden in the main body.

2. The portable storage device of claim 1, wherein the connecting portion is a universal serial bus (USB) terminal.

3. The portable storage device of claim 1, wherein the connecting line has a spring portion.

4. The portable storage device of claim 1, wherein the lamp portion is a light emitting diode (LED).

5. The portable storage device of claim 1, wherein the main body further comprises a light-directing portion corresponding to the lamp portion.

6. The portable storage device of claim 1, wherein the main body further comprises a hanging portion.

7. A portable storage device capable of being abreast used with another device comprising:
a main body having a lamp portion; and
a connecting portion connected to the main body via a connecting line, the connecting portion being moved to and situated at a first position and a second position;
wherein when the connecting portion is situated at the first position, the connecting portion and a part of the connecting line are exposed outside the main body.

8. The portable storage device of claim 7, wherein when the connecting portion is situated at the second position, the connecting portion is exposed outside the main body.

9. The portable storage device of claim 7, wherein when the connecting portion is situated at the second position, the connecting portion is hidden in the main body.

10. The portable storage device of claim 7, wherein the connecting portion is a universal serial bus (USB) terminal.

11. The portable storage device of claim 7, wherein the connecting line has a spring portion.

12. The portable storage device of claim 7, wherein the lamp portion is a light emitting diode (LED).

13. The portable storage device of claim 7, wherein the main body further comprises a light-directing portion corresponding to the lamp portion.

14. The portable storage device of claim 7, wherein the main body further comprises a hanging portion. portion.
